(19) United States
(12) Patent Application Publication
(10) Pub. No.: US 2017/0161069 A1
(43) Pub. Date: Jun. 8, 2017

(54) MICROPROCESSOR INCLUDING PERMUTATION INSTRUCTIONS

(71) Applicant: KNUEDGE, INC., San Diego, CA (US)

(72) Inventors: Don Yokota, San Marcos, CA (US); Douglas A. Palmer, San Diego, CA (US)

(73) Assignee: KNUEDGE, INC., San Diego, CA (US)

(21) Appl. No.: 14/962,649

(22) Filed: Dec. 8, 2015

(51) Int. Cl. G06F 9/30

(52) U.S. Cl. CPC G06F 9/30029; G06F 9/30018; G06F 9/30105

(57) ABSTRACT

Combinational circuits in a microprocessor execute instructions to perform permutations on bits of a source byte in a single clock cycle. Each bit in the source byte is permuted in accordance with a permutation map. The only storage within the processor core required to execute these instructions is that needed to hold the source byte, the permutation map, and the result byte. Using the permutation instructions and byte swap instructions, a wide variety of permutation operations can be performed on a word, which in the example circuits is 32 bits.

### BACKGROUND

The instruction sets of modern computer Central Processing Units (CPUs) typically include a variety of commands to manipulate data stored in operand registers. Each operand register may hold a “word.” A “word” is a fixed-sized piece of data, such as a quantity of data handled as a unit by the instruction set and/or the processor core of the CPU, and can vary from CPU to CPU. For example, a “word” might be 32 bits on one type of CPU, whereas a “word” might be 64 bits on another type of CPU. In some applications such as encryption, it is desirable to go inside a “word” and individually manipulate the stored bits.

### BRIEF DESCRIPTION OF DRAWINGS

For a more complete understanding of the present disclosure, reference is now made to the following description taken in conjunction with the accompanying drawings.

FIGS. 1-3 illustrate examples of a source byte being permutated.

FIG. 4 illustrates an instruction format used to encode the permutation instructions.

FIG. 5 illustrates the structure of an example of a 32-bit operand register.

FIGS. 6A and 6B illustrate an example structure of a source byte to be acted upon by a permutation instruction, as stored in an operand register.

FIGS. 7A and 7B illustrate an example structure of a result byte produced by the permutations, as stored in an operand register.

FIGS. 8A and 8B illustrate an example structure of a permutation map to be applied to the source byte, as stored in an operand register.

FIG. 9 is a block diagram conceptually illustrating example components of a processor core configured to execute instructions including the permutation instructions.

FIG. 10 is a block diagram expanding upon the micro-sequencer of the core in FIG. 9.

FIG. 11 illustrates an example of a process flow utilized by the processor core in FIGS. 9 and 10 to execute an instruction.

FIG. 12 illustrates how the components of the pipeline architecture of the processor core advance through different stages in parallel.

FIG. 13 illustrates an example of a circuit to decode the permutation map for a single bit of the source byte.

FIG. 14 is a logic table illustrating how each state of the permutation map for a single bit of the source byte will be decoded by the circuit in FIG. 13.

FIG. 15 illustrates a circuit to execute a “permute bits with XOR” (PERBX) instruction, producing a single bit of the result.

FIG. 16 illustrates a circuit including multiple copies of the circuit in FIG. 15, to perform a PERBX on an 8-bit source to produce an 8-bit result.

FIG. 17 illustrates a circuit to execute a “permute bits with AND” (PERBA) instruction, producing a single bit of the result.

FIG. 18 illustrates a circuit including multiple copies of the circuit in FIG. 17, to perform a PERBA on an 8-bit source to produce an 8-bit result.

### DETAILED DESCRIPTION

Reduced instruction set computing (RISC) instruction sets typically include instructions that support basic “word” manipulation operations such as masks, bit shifts and bitwise logic operations. Instructions to apply “masks” to words are used to set some bits in the word while leaving others untouched. “Shift” operations may shift bits within the words toward the beginning or end of the word. Examples of basic bitwise logic operations include logic operations such as “AND,” inclusive “OR,” or “Exclusive OR” (XOR). In comparison, complex instruction set computing (CISC) instruction sets typically include instructions that can perform a series of these basic operations as multiple steps using a single instruction call.

Unfortunately, using conventional techniques, rearranging the order of bits stored in a source register, when copying the bits to a destination register, can require executing a relatively large number of instructions, particularly if the new order is arbitrary. This act of rearranging bits into a different sequence or order is called “permuting.” On a typical processor (RISC or CISC), a simple permutation operation may require around twenty different instructions to be executed to permute a single byte of data.

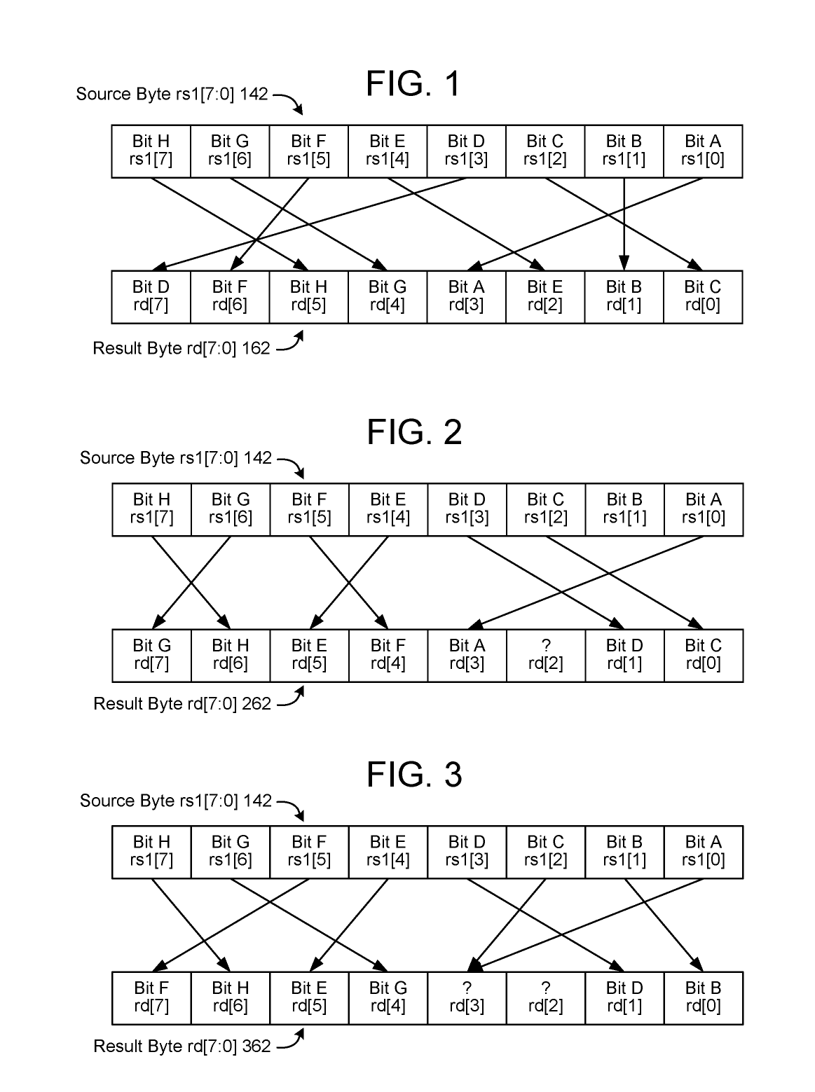

FIG. 1 illustrates an example of a source byte rs1[7:0] 142 permuted to produce a result byte rd[7:0] 162. As used herein, the notation “value[y:x]” refers to a range of bits in a series “value”, where “x” is the least-significant bit (LSB) in the series (i.e., the bit corresponding to the smallest value in the series), and “y” is the most significant bit (MSB) in the series (i.e., the bit corresponding to the greatest value in the series). The notation “value[z]” refers to a specific bit in the series “value.” So for example, rs1[7:0] refers to the entire byte (all eight bits) of the source byte rs1 142 in FIG. 1, whereas rs1[3] refers to the fourth bit of the source byte rs1, which in FIG. 1 is labelled as having a true/false state “Bit D” (counting up from least significant rs1[0], which in FIG. 1 is labelled as having a true/false state “Bit A”).

The reordering of the bits illustrated in FIG. 1 is arbitrary. The number of operations required to perform such an arbitrary permutation may vary depending upon the relative complexity of the moves. That is to say, if the pattern of the permutation varies from permutation to permutation, the number of instructions required to execute each permutation may also vary. Variation in the number of instructions required to perform a permutation results in a similar variation in the amount of time (in terms of CPU clock cycles) needed to perform each permutation operation. Variation in the amount of time needed to perform each permutation is undesirable, particularly in applications where multiple permutations are being performed in parallel and a next process step requires waiting for multiple permutations to be completed before continuing.

FIG. 2 illustrates an example of a different permutation. Seven of the eight bits of the source byte rs1[7:0] 142 are copied to a result byte rd[7:0] 262 in a different order, with the state of one source bit (Bit B in rs1[1]) not being copied at all. While a sequence of instructions might be written using a conventional instruction set (e.g., either RISC or CISC) to perform the illustrated operation, the particular instructions used and overall number instructions might vary from what would be used for the permutation in FIG. 1. Depending upon the instructions used, an extra operation may be required to set a state of the result bit rd[2] that does not receive a permuted source bit.

FIG. 3 illustrates another example of a permutation, where bits from the source byte rs1[7:0] 142 are again reordered in the result byte rd[7:0] 362, with the states of two bits (Bit A in rs1[0] and Bit C in rs1[2]) copied to the same result bit (to rd[3]). The result bit rd[2] does not receive a permuted source bit. Unless consistent rules are imposed for how to handle the copying multiple bits to a same result bit, the final result may be unpredictable. To prevent this, at the cost of additional clock cycles, additional instructions can be imposed, such as performing an AND, OR, or XOR operation when multiple bits are copied to a same destination bit. Otherwise, the result may be that the last bit copied to the result bit, such that the final result may depend upon the order of the operations.

An “AND” is a logical operation where the binary inputs are multiplied, such that the output of an AND is true (1) if and only if all of the inputs are true (1). Otherwise, if any input is false (0), an AND outputs a false (0). An “OR” is a logical operation where the binary inputs are added, such that the output of an OR is false (0) if and only if all of the inputs are false (0). Otherwise, if any input is true (1), an OR outputs a true (1). An “XOR” is a logical operation that outputs a true (1) if and only if an odd number of inputs are true (1). Otherwise, an XOR outputs a false (0).

There have been past attempts at improving the performance of permutation operations, but the results have had various shortcomings. One well-known solution was based upon bit-matrix multiplication. An example is described in “Bit Matrix Multiplication in Commodity Processors” by Yedidya Hilewitz, Cedric Lauradoux, and Ruby B. Lee, IEEE International Conference on Application-Specific Systems, Architectures and Processors (ASAP), 2008, page 7-12, and in Yedidya Hilewitz's related 2008 Princeton PhD dissertation entitled “Advanced Bit Manipulation Instructions: Architecture, Implementation and Applications.”

However, bit matrix multiplication solutions need to store tables of data that specify how to manipulate bits. This need for storage is a major drawback, and limits the practicality of bit-matrix multiplication as a solution on most processors. In a typical implementation, the stored tables are estimated to require approximately 1 Kilobyte (KB) of memory (i.e., 8000 bits). While 1 KB may seem tiny relative to the amount of memory in today's computers, it can be huge relative to the amount of data storage available within a processor core's internal registers, which are what a core uses when executing instructions. An alternative might be to store the tables in memory outside the processor's core and load data from the tables as needed. However, the use of multiple memory swap transactions will considerably reduce the time required to perform bit-matrix multiplication, due to the added latency introduced by the extra transactions.

Disclosed herein are permutation instructions, and circuits for executing the instructions, that can perform arbitrary permutations on a source byte in a single clock cycle. Each bit in the source byte is permuted in accordance with a permutation map. The only storage within the processor core required to execute these instructions is the register holding the source byte “rs”, the register “rd” that will receive the result of the permutation, and the register or registers storing the permutation map. With just two new permutation instructions and a byte swap instruction, it becomes possible to do most any kind of permutation operation on a word, which in the example system is 32 bits.

A first new instruction is a Permute Bits with XOR (“PERBX”) and a second new instruction is a Permute Bits with AND (“PERBA”). With both instructions, each source bit is mapped independently, such that it is possible to map more than one source bit to a single destination bit (e.g., as illustrated in FIG. 3). The difference between these instructions is how they handle multiple source bits being written to a single destination bit.

With the PERBX instruction, if no bit is mapped to a target bit, the target bit is set to zero (0). If a single source bit is mapped to a target bit, then the target bit is set to the state of the source bit. If multiple source bits are mapped to a target bit, than the destination bit is set to a logical Exclusive-OR (XOR) of those mapped source bits. As noted above, an XOR is a logical operation that outputs a true (1) only when an odd number of inputs are true (1). Otherwise, an XOR outputs a false (0).

Applying XOR transforms to data is believed to be particularly advantageous for cryptography. A byte can be permuted to be completely unrecognizable, but if the original permutation map is known, then depending in part on the number of bits copied to a same bit and the duplication of those bits in the result, the original source byte may be recoverable, making the process reversible. This reversibility is possible because each output bit that is written to by multiple source bits will only be true if an odd number of inputs are true, such that the original bit states may be recovered in manner similar to data recovered using a parity bit.

With the PERBA instruction, if no bit is mapped to a target bit, the target bit is set to zero (0). If a single source bit is mapped to a target bit, then the target bit is set to the state of the source bit. If multiple source bits are mapped to a target bit, than the destination bit is set to a logical AND of those mapped source bits. As noted above, an AND is a logical operation that outputs a true (1) only when all of the inputs are true (1). Otherwise, an AND outputs a false (0).

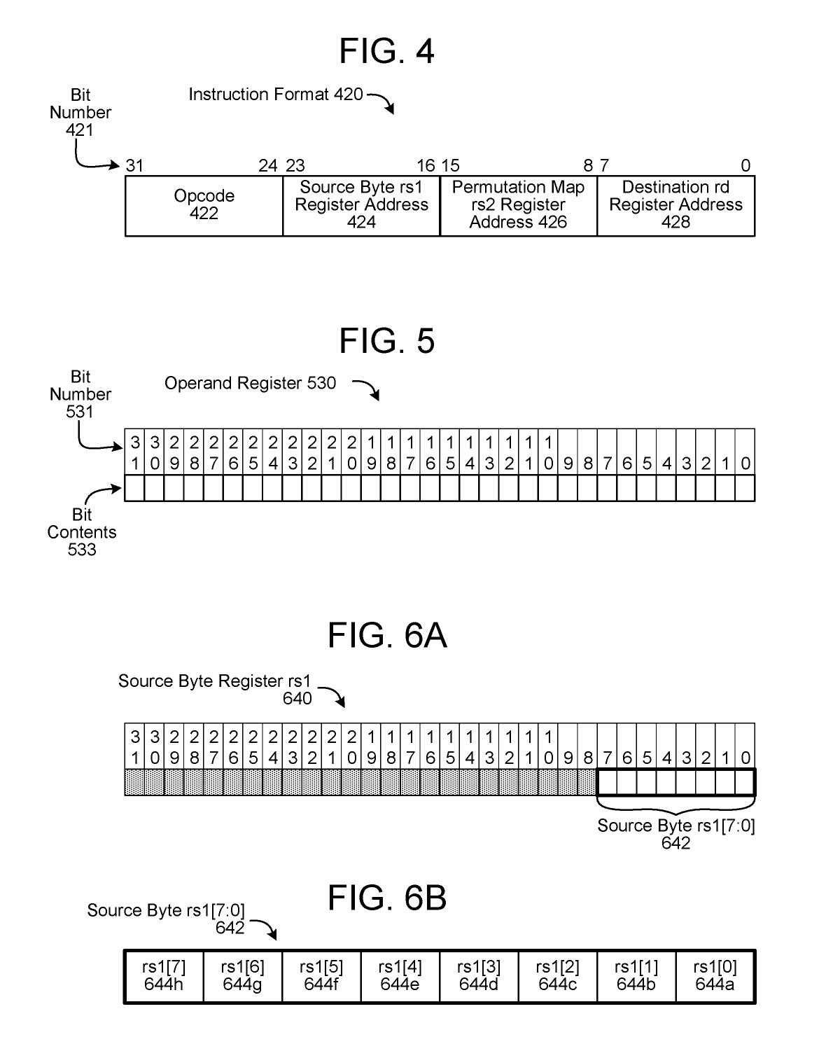

FIG. 4 illustrates an example of an instruction format 420 that may be used for PERBA and PERBX in a system that uses 32-bit instructions. Referring to the most-significant to least-significant bit numbers 421, the opcode 422 specifying either PERBA or PERBX is 8 bits (bits 31:24). In computing, an “opcode” (abbreviated from operation code) is the portion of a machine language instruction that specifies the operation to be performed. The opcode is followed by addresses of the source byte rs1, permutation map rs2, and destination byte rd are stored in the processor core's operand registers. The source byte rs1 register address 424 is specified by eight bits (bits 23:16), the permutation map rs2 register address is specified by another eight bits (bits 15:8), and the destination byte rd register address is specified by the last eight bits (7:0).

As can be inferred from the example instruction format 420 in FIG. 4, the core executing the instruction may have up to 256 operand registers, based on the address for each of the registers being eight bits (i.e., 2⁸ equals 256). Although the examples will be discussed using a 32-bit instruction set for a core that has up to 256 operand registers, the principles of operation apply equally to other arrangements. For example in a core that supports 64-bit wide instructions, there may be capacity for wider operand register addresses (e.g., sixteen bits per operand address, supporting up to 65,536 operand registers). Also, although the instruction format 420 is illustrated as a single 32-bit word instruction format, the instructions might also be implemented as a plurality of words. For instance, a first 32-bit word may include a 16-bit opcode and a 16-bit source byte rs1 register address, and a second 32-bit word may include a 16-bit permutation map rs2 register address and a 16-bit designation byte register address. The instruction format may also be adapted to operate on cores that operate with words. For example, in a core designed for sixteen-bit words, an eight bit opcode and an eight bit source byte rs1 register address may be loaded in a first 16-bit word, and an 8-bit permutation map rs2 register address and an 8-bit destination byte rd register address may be loaded in a second 16-bit word.

FIG. 5 illustrates an example structure of an operand registers 530, as will be used to further explain operations using the permutation instructions. As annotated by the bit numbers 531, the bit contents 533 of each operand register 530 constitute a thirty-two bit word.

FIG. 6A illustrates a source byte register rs1 640, as addressed by the source byte register address 424 in the instruction format 420. The source byte itself constitutes the least-significant 8-bits of the register, illustrated as source byte rs1[7:0] 642. FIG. 6B further illustrates the source byte rs1[7:0] 642, labelling each bit from rs1[7] 644h to rs1[0] 644a.

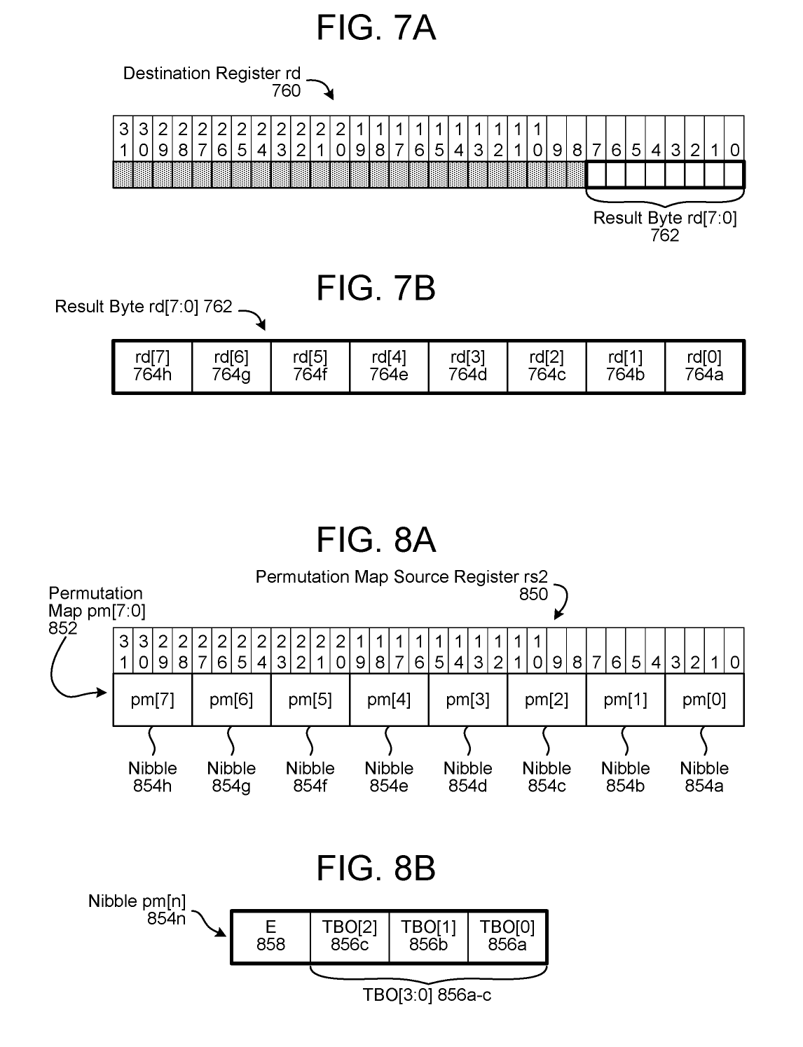

FIG. 7A illustrates a destination byte register rd 760, as addressed by the destination byte register address 428 in the instruction format 420. The destination byte itself constitutes the least-significant 8-bits of the register, illustrated as destination byte rd[7:0] 762. FIG. 7B further illustrates the designation byte rd[7:0] 762, labelling each bit from rd[7] 764h to rd[0] 764a.

FIG. 8A illustrates a permutation map source register rs2 850, as address by the permutation map rs2 register address 426 in the instruction format 420. The permutation map pm[7:0] 852 constitutes eight four-bit “nibbles,” arranged from nibble pm[7] 854h to nibble pm[0] 854a. Each nibble corresponds to one bit of the rs1 byte 642 to be permuted. Nibble zero pm[0] 854a specifies the mapping for source bit zero (i.e., rs1[0] 644a), nibble one pm[1] 854b specifies the mapping for source bit one (i.e., rs1[1] 644b), and so on up through nibble seven pm[7] 854h, which specifies the mapping for source bit seven (i.e., rs1[7] 644h).

As illustrated in FIG. 8B, each four bit nibble pm[n] 854n includes a three-bit data field TBO[3:0] 856a-c (TBO being an acronym for “target bit offset”) and a one-bit data field “E” 858. The target-bit offset data field 856a-c specifies binary number that is an offset that may be applied to a source bit in the source byte rs1 642 when that bit is copied to the result byte 762 in the destination register rd 760. So for example, referring back to FIG. 1, the TBO data field of the nibble pm[0] might specify that the offset is 3, resulting in the state “Bit A” of source bit rs1[0] being permuted in the result to bit rd[3]. Likewise, if the TBO data field of nibble pm[1] specifies an offset of zero, the state “Bit B” of source bit rs1[1] is permuted to the result bit rd[1].

The “E” data field 858 of each nibble pm[n] 854n specifies whether a source bit rs1[n] is or is not to be mapped to the destination register rd 760. If “E” is equal to true (1), the source bit is not mapped. Otherwise, if “E” is equal to false (0), the source bit is mapped as specified by the offset in the TBO data field. For example, referring back to FIG. 2, setting the “E” data field of nibble pm [1] equals to true (1) would result in the “Bit B” state of the source bit rs1[1] not being mapped into the result byte 262, as illustrated.

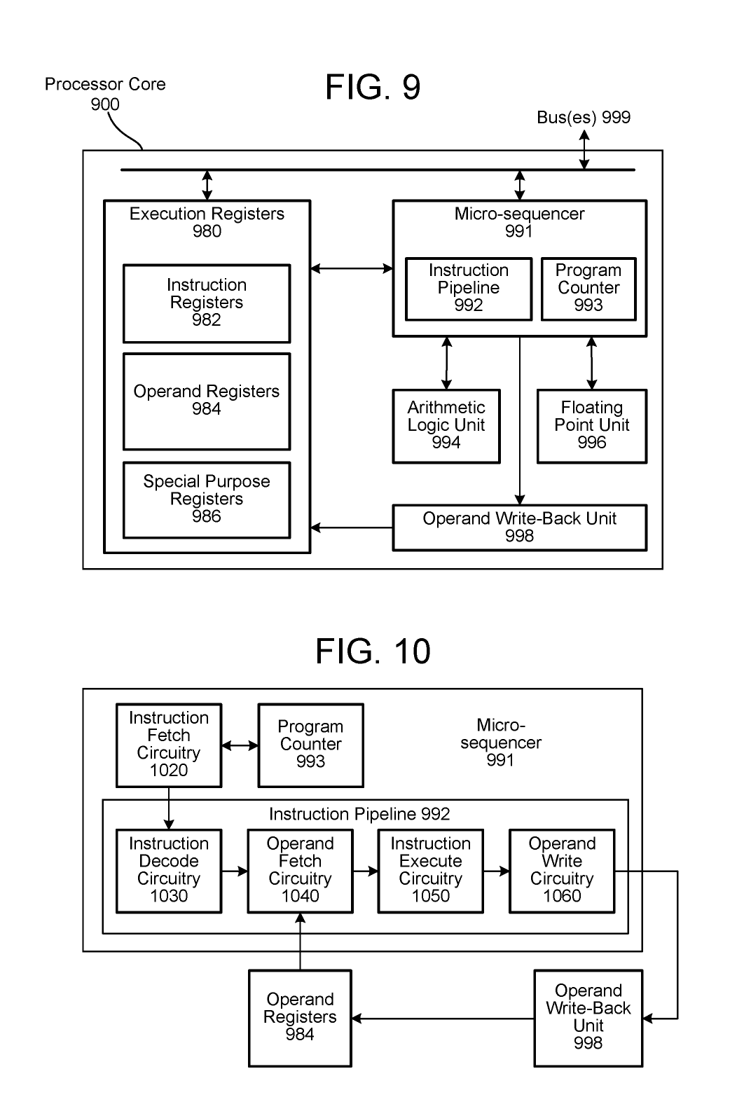

To provide context for details relating to the execution of the PERBA and PERBX operations, FIG. 9 is a block diagram conceptually illustrating example components of a processor core 900 configured to execute instructions including the permutation instructions. The processor core 900 may be of a conventional “pipelined” design, but as will be described further below, includes additional circuitry in (or associated with) its instruction execution stage to perform the permutation operations.

The processor core 900 includes a plurality of execution registers 980 that are used by the core 900 to perform operations. The registers 980 may include, for example, instruction registers 982, operand registers 984, and various special purpose registers 986. These registers 980 are ordinarily for the exclusive use of the core 900 for the execution of operations. Instructions and data are loaded into the execution registers 980 to “feed” an instruction pipeline 992. While a processor core 900 may experience no latency (or a latency of one-or-two cycles of the clock controlling timing of a micro-sequencer 991) when accessing its own execution registers 980, accessing memory that is external to the core 900 may produce a larger latency due to (among other things) the physical distance between the core 900 and the memory.

The instruction registers 982 store instructions loaded into the core (e.g., via bus(es) 999) that are being/will be executed by an instruction pipeline 992. The operand registers 984 have the structure 530 and store data that has been loaded into the core 900 that is to be processed by an executed instruction (e.g., registers serving as the source byte register rs1 640 and permutation map source register rs2 850). The operand registers 984 also receive the results of operations executed by the core (e.g., a register serving as the destination register rd 760). The special purpose registers 986 may be used for various “administrative” functions, such as being set to indicate divide-by-zero errors, to increment or decrement transaction counters, to indicate core interrupt “events,” etc.

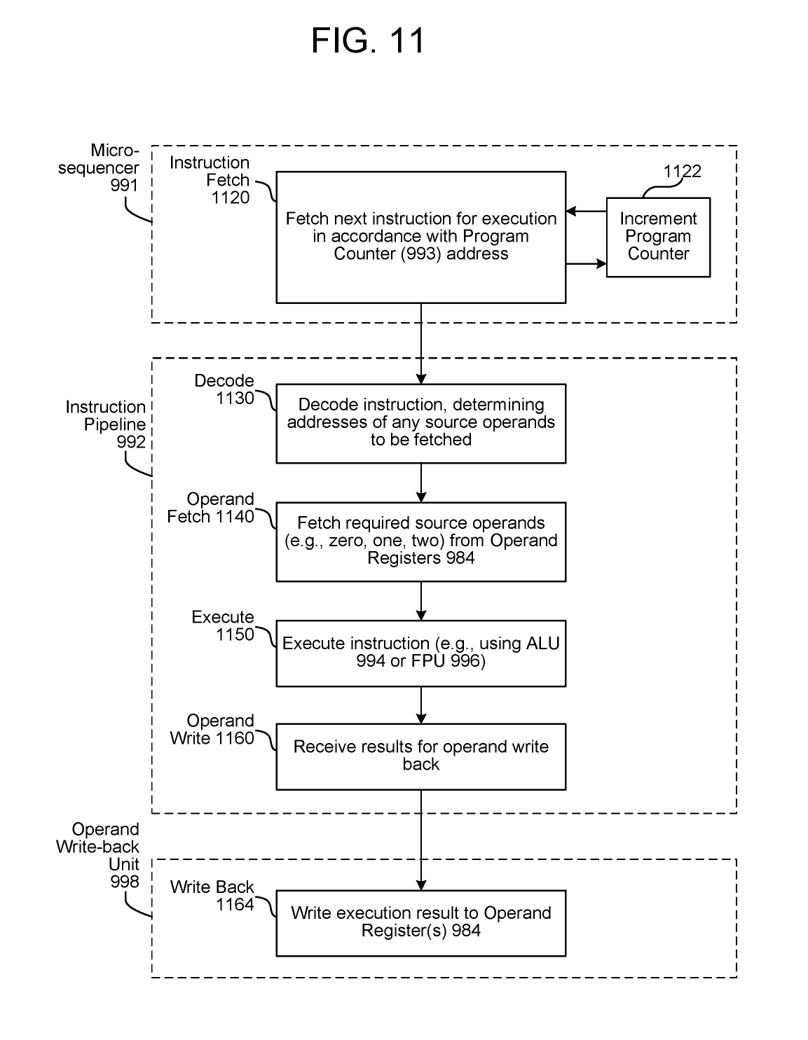

Referring to FIGS. 9, 10, and 11, the instruction fetch circuitry 1020 of a micro-sequencer 991 fetches (1120) a stream of instructions for execution by the instruction pipeline 992 in accordance with an address generated by a program counter 993. The micro-sequencer 991 may, for example, may fetch an instruction every “clock” cycle, where the clock is a signal that controls the timing of operations by the micro-sequencer 991 and the instruction pipeline 992.

The instruction pipeline 992 comprises a plurality of “stages,” such as an instruction decode stage, an operand fetch stage, an instruction execute stage, and an operand write-back stage. Each stage corresponds to circuitry.

The instruction fetch circuitry 1020 provides the fetched instruction to instruction decode circuitry 1030 of an instruction pipeline 992. The decode circuitry 1030 decodes (1130) the instruction, and determines the addresses of any source operands that need to be fetched, such as the source byte rs1 specified by the source byte register address 424 and the permutation map rs2 specified by the permutation map register address 426.

The instruction decode circuitry 1030 provides the addresses of the operands that need to be fetched to operand fetch circuitry 1040 of the instruction pipeline 992. The operand fetch circuitry 1040 fetches (1140) the required source operands (e.g., zero, one, or two operands) from the operand registers 984. The operand fetch circuitry 1040 provides the fetched operands to instruction execute circuitry 1050 of the instruction pipeline 992. The instruction execute circuitry 1050 executes (1150) the decoded instruction, using the fetched operands. Certain instructions may be presented by the instruction execute circuitry 1050 to an arithmetic logic unit (ALU) 994 for execution. The ALU may be configured to execute arithmetic and logic operations using the source operands. Typically, execution by the ALU 994 may be performed in a single cycle of the clock, with extended instructions requiring two or more cycles. The instruction execute circuitry 1050 may also use other specialized components to execute instructions, such as a floating point unit (FPU) 996.

Results from the execution (1150) of the decoded instruction (if any) are provided to operand write circuitry 1060 of the instruction pipeline 992. The operand write circuitry 1060 performs 1160 a “write back,” providing the result(s) and the address(es) of the operand register(s) to which the result(s) are to be written to an operand write-back unit 998. The operand write-back unit 998 then writes (1164) the results into the specified operand registers 984. Depending upon the size of the resulting operand(s) and the size of the operand registers, extended operands that are longer than a single register may require more than one clock cycle to write-back.

Register forwarding may also be used to forward an operand result back into the execution instruction execute circuitry 1050 for a next or subsequent instruction in the instruction pipeline 992, to be used as a source operand for execution of that instruction. For example, a compare circuit may compare the register source address of a next instruction with the register result destination address of the preceding instruction, and if they match, the execution result operand may be forwarded between pipeline stages to be used as the source operand for execution of the next instruction, such that the execution of the next instruction does not need to fetch the operand from the registers 984.

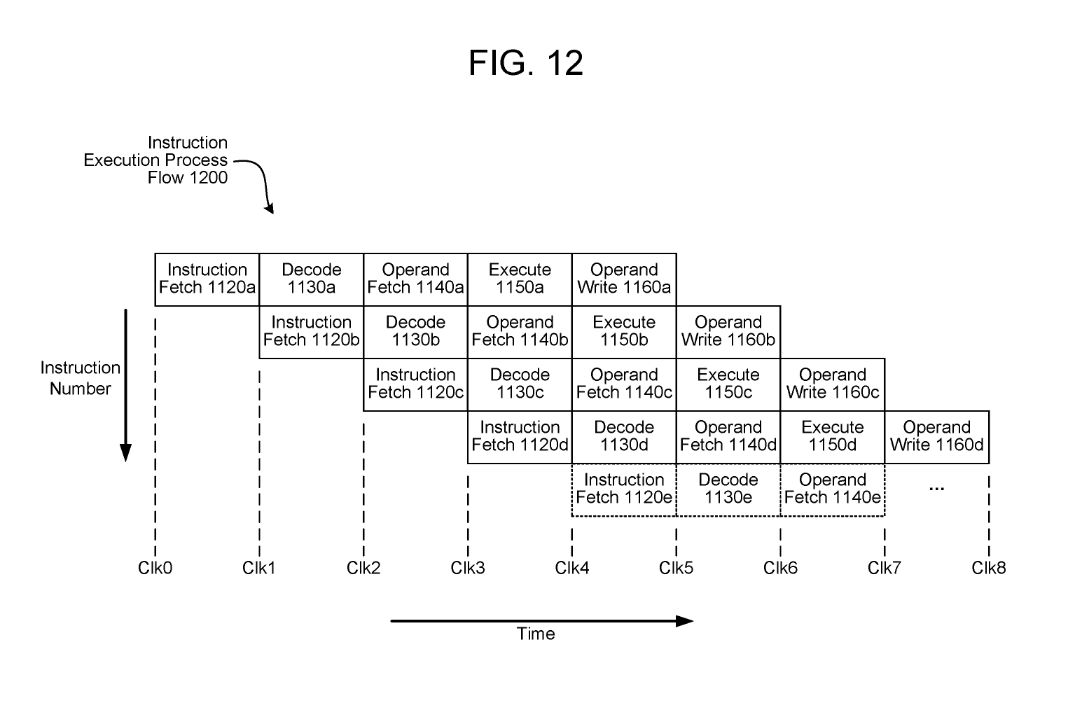

FIG. 12 illustrates how the components of the pipeline architecture of the processor core 900 advance through different the micro-sequencer 991 and instruction pipeline 992 stages in parallel. As noted in the discussion of FIGS. 9 to 11, each stage of the flow may take as little as one cycle of the clock used to control timing. Although the illustrated instruction execution process flow 1200 is scalar, a processor core 900 may implement superscalar parallelism, such as a parallel pipeline where two instructions are fetched and processed on each clock cycle.

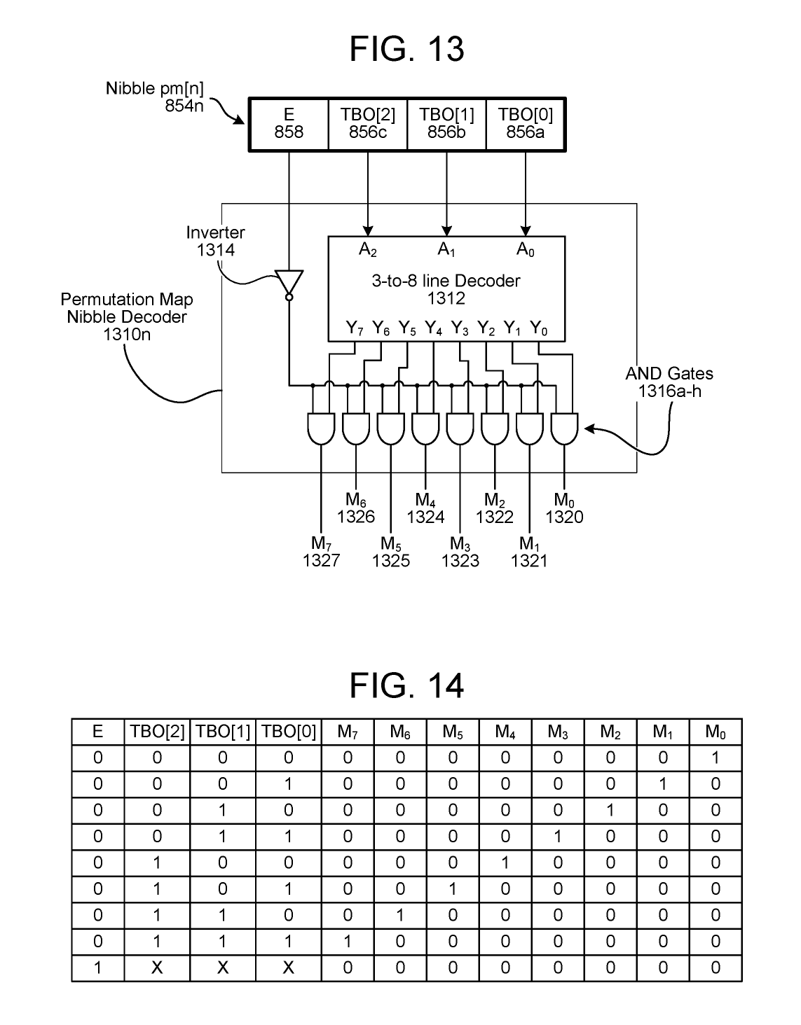

FIGS. 13, 15, and 16 illustrate combinational logic that executes a PERBX instruction. FIGS. 13, 17, and 18 illustrate combinational logic that executes a PERBA instruction. “Combinational logic” is time-independent logic circuitry implemented by Boolean circuits, where the output is a pure function of the present input only. This is in contrast to sequential logic, in which the output depends not only on the present input but also on previous inputs. In other words, sequential logic has some type of memory capability while combinational logic does not.

FIG. 13 illustrates an example of a permutation map nibble decoder circuit 1310n that is used to decode the permutation map for a single bit rs1[n] of the source byte 642. The illustrated circuit 1310n is a component of the larger circuits that execute the PERBA and PERBX instructions. The target bit offset data field bits TBO[2:0] 856a-c of a nibble pm[n] 854n of the permutation map XXE52 is input into inputs A₀ to A₂ of a 3-to-8 line decoder 1312. Based on the target bit offset value, one of the outputs Y₀ to Y₇ of the decoder 1312 is set to true (1), and the other output are set to false (0).

The “E” data field bit 858 is inverted by an inverter 1314. An inverter performs a “NOT” operation, with the output of a NOT being the opposite of its input, such that a true (1) becomes false (0), and a false (0) becomes true (1). The output of a NOT operation may be noted by an exclamation point “!” added to its input, such that NOT rs1[0] may be expressed as !rs1[0].

The outputs Y₀ to Y₇ of the decoder 1312 are each connected to one input of a corresponding two-input AND gate (1316a to 1316h). For example, output Y₀ is input into AND gate 1316a, output Y₁ is input into AND gate 1316b, output Y₂ is input into AND gate 1316c, and so on, with output Y₇ being input into AND gate 1316h. The other input of each AND gate 1316a-h receives the output of the inverter 1314 (i.e., the inverted “E” data field value). The eight outputs M₀ 1320 to M₇ 1327 of the map decoder 1310m are the outputs of the eight AND gates 1316a-h, where the output of AND gate 1316a is decoder output M₀ 1320, the output of AND gate 1316b is decoder output M₁ 1321, and so on, with the output of AND gate 1316h being decoder output M₇ 1327.

FIG. 14 is a logic table illustrating how each state of a permutation map nibble pm[n] 854n will be decoded by the circuit in FIG. 13. An “X” in the table indicates that the value of that bit does not affect the output state.

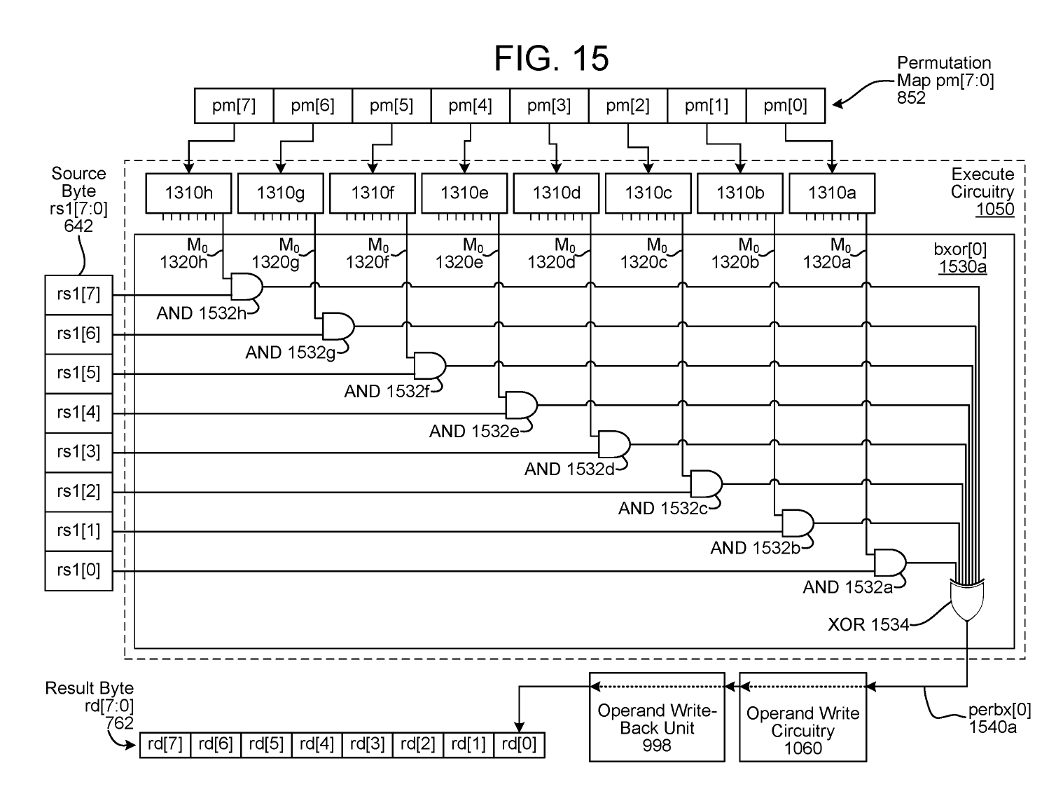

FIG. 15 illustrates a circuit to execute a “permute bits with XOR” (PERBX) instruction, producing a single bit rd(0) 764a of the result byte rd[7:0] 762. Each nibble pm[0] 854a to pm[7] 854h of the permutation map 852 is input into a corresponding permutation map nibble decoder 1310a to 1310h (as illustrated in FIG. 13). Since the example in FIG. 15 focuses on determining the value of the least-significant bit (LSB) rd[0] 764a of the result byte rd[7:0] 762, the LSB output of each decoder 1310a to 1310h are used (i.e., the M₀ outputs 1320a to 1320h).

Each M₀ output 1320a to 1320h serves as one of the inputs into a corresponding two-input AND gate 1532a to 1532h. The other input of each AND gate 1532a to 1532h receives a corresponding bit rs1[0] 644a to rs1[7] 644h of the source byte rs1[7:0] 642. So the inputs into AND gate 1532a are M₀ 1320a and rs1[0] 644a, the inputs into AND gate 1532b are M₀ 1320b and rs1[1] 644b, the inputs into AND gate 1532c are M₀ 1320c and rs1[2] 644c, and so on, with the inputs into AND gate 1532h being M₀ 1320h and rs1[7] 644h.

The outputs of all the AND gates 1532a to 1532h are input into an eight-input XOR gate 1534. The output of XOR gate 1534 is the least-significant of perbx[0] 1540a of the PERBX permutation result. The operand write circuitry 1060 provides perbx[0] 1540a to the operand write-back unit 998 to be written to the destination register rd 760 as the least-significant bit rd[0] 764a of the result byte rd[7:0] 762.

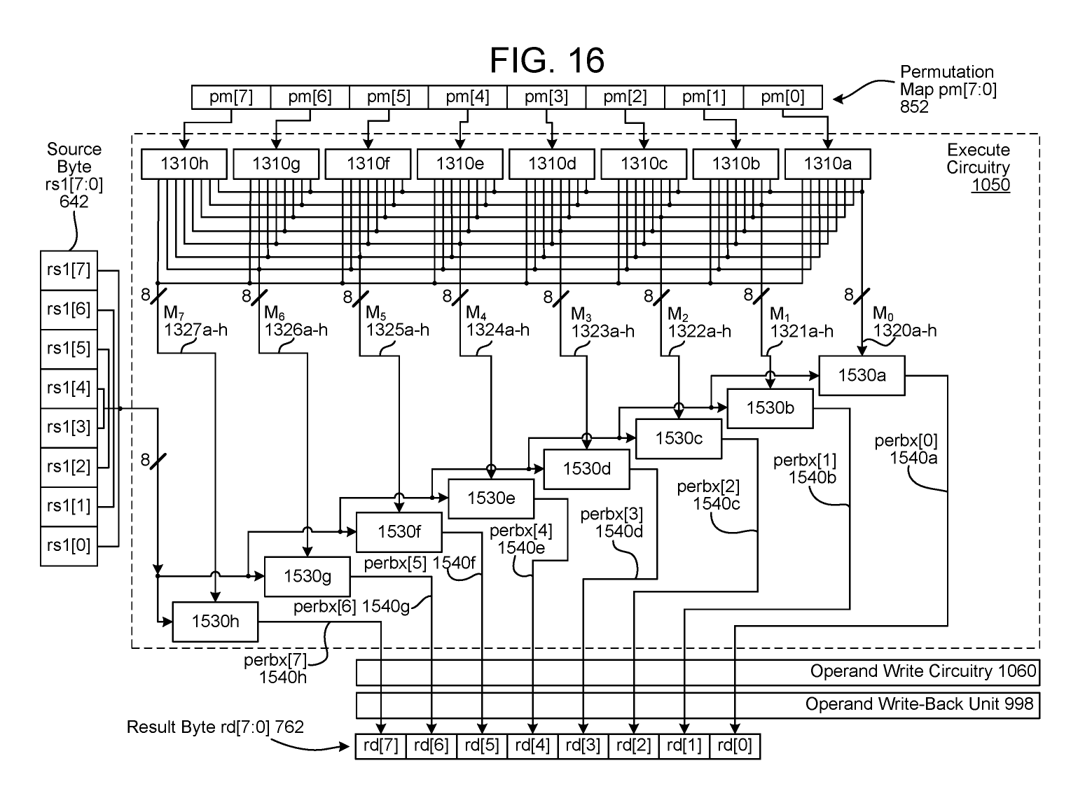

The AND gates 1532a to 1532h and the XOR gate 1534 form a circuit bxor[0] 1530a that outputs one bit of the permutation perbx[0] 1540a. This circuit bxor[n] 1530 is duplicated for each of the bits [7:0] of the PERBX result byte. This is further illustrated in FIG. 16, where the circuits bxor[7:0] 1530a to 1530h combine to produce the permuted byte perbx[7:0] 1540a-1540h.

In FIG. 16, the eight M₀ outputs 1320a-h, as output by the eight permutation map nibble decoders 1310a-h, are input into the circuit bxor[0] 1530a, producing result bit perbx[0] 1540a. The eight M₁ outputs 1321a-h, as output by the eight permutation map nibble decoders 1310a-h, are input into a circuit bxor[1] 1530b, producing result bit perbx[1] 1540b. The eight M₂ outputs 1322a-h, as output by the eight permutation map nibble decoders 1310a-h, are input into a circuit bxor[2] 1530c, producing result bit perbx[2] 1540c. And so on, with the eight M₇ outputs 1327a-h, as output by the eight permutation map nibble decoders 1310a-h, being input into the circuit bxor[7] 1530h, producing result bit perbx[7] 1540h. Thus, the circuit in FIG. 16 executes the PERBX instruction to permute the source byte rs1[7:0] 642 into the result byte rd[7:0] 762.

The permutation map nibble decoders 1310a-h and the circuits bxor[7:0] 1530a-h may be part of the execute circuitry 1050 of the instruction pipeline 992, or may be included in circuitry associated with the execute circuitry 1050 of the instruction pipeline 992, such as in an ALU 994. In this way, the execute stage (1150) may execute an entirety of a PERBX instruction within a signal clock cycle.

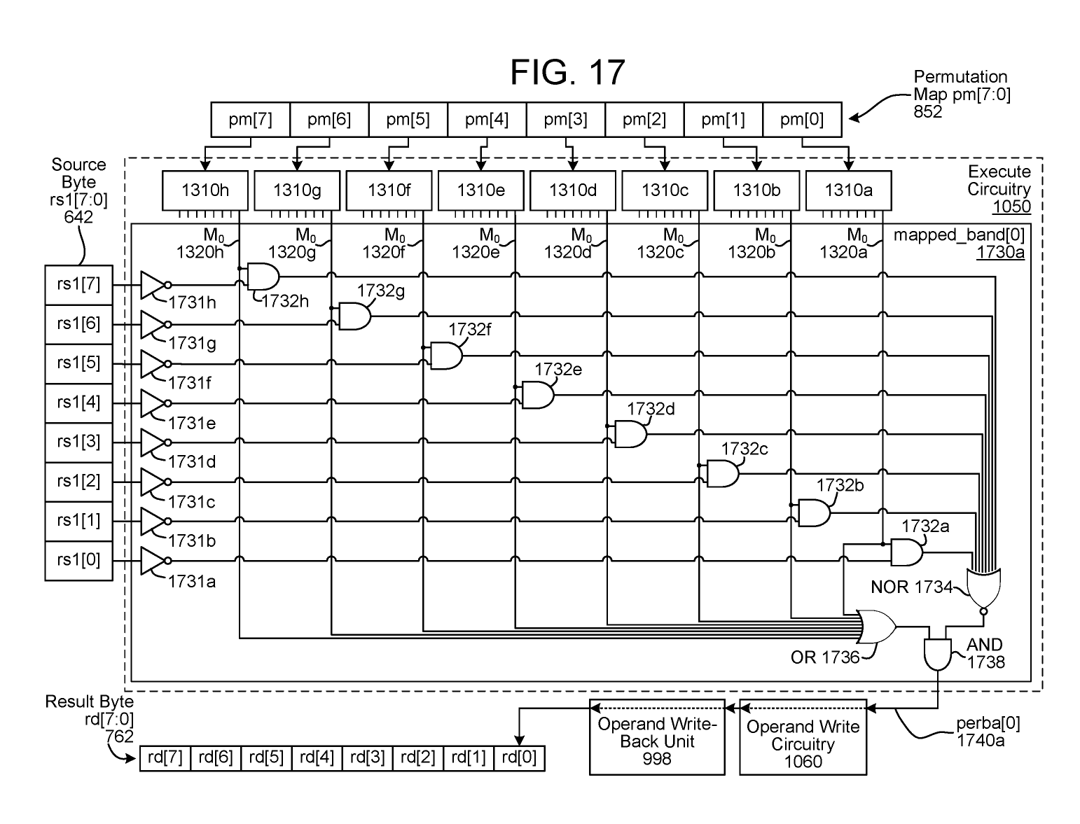

FIG. 17 illustrates a circuit to execute a “permute bits with AND” (PERBA) instruction, producing a single bit rd(0) 764a of the result byte rd[7:0] 762. Each nibble pm[0] 854a to pm[7] 854h of the permutation map 852 is input into a corresponding permutation map nibble decoder 1310a to 1310h (as illustrated in FIG. 13). Since the example in FIG. 17 focuses on determining the value of the least-significant bit (LSB) rd[0] 764a of the result byte rd[7:0] 762, the LSB output of each decoder 1310a to 1310h are used (i.e., the M₀ outputs 1320a to 1320h).

Each M₀ output 1320a to 1320h serves as one of the inputs into a corresponding two-input AND gate 1732a to 1732h. Eight inverters 1731a-h invert the bits rs1[0] 644a to rs1[7] 644h of the source byte rs1[7:0] 642. The inverted source byte bits output by the inverters 1731a-h are each input into a corresponding AND gate 1732a to 1732h. So the inputs into AND gate 1732a are M₀ 1320a and !rs1[0], where the exclamation point indicates that the state of the bit is inverted by the NOT operation of the inverter. Likewise, the inputs into AND gate 1732b are M₀ 1320b and !rs1[1], the inputs into AND gate 1732c are M₀ 1320c and !rs1[2], and so on, with the inputs into AND gate 1732h being M₀ 1320h and !rs1[7].

The outputs of all the AND gates 1732a to 1732h are input into an eight-input NOR gate 1734. A “NOR” operation corresponds to an OR with an inverted output, such that the output of a NOR is true (1) if and only if all of the inputs are false (0). Otherwise, if any input is true (1), a NOR outputs a false (0).

All of the outputs M₀ 1320a-h from the permutation map nibble decoders 1310a-h are also input into an eight-input OR gate 1736. The output of the OR gate 1736 will be true (1) if any of the bits of the source byte rs1[7:0] 642 are mapped to the result bit rd[0] 764a.

The outputs of the OR gate 1736 and the NOR gate 1734 are input into an AND gate 1738. The output of AND gate 1738 is the least-significant bit perba[0] 1740a of the PERBA permutation result. The operand write circuitry 1060 provides bit perba[0] 1740a to the operand write-back unit 998 to be written to the destination register rd 760 as the least-significant bit rd[0] 764a of the result byte rd[7:0] 762.

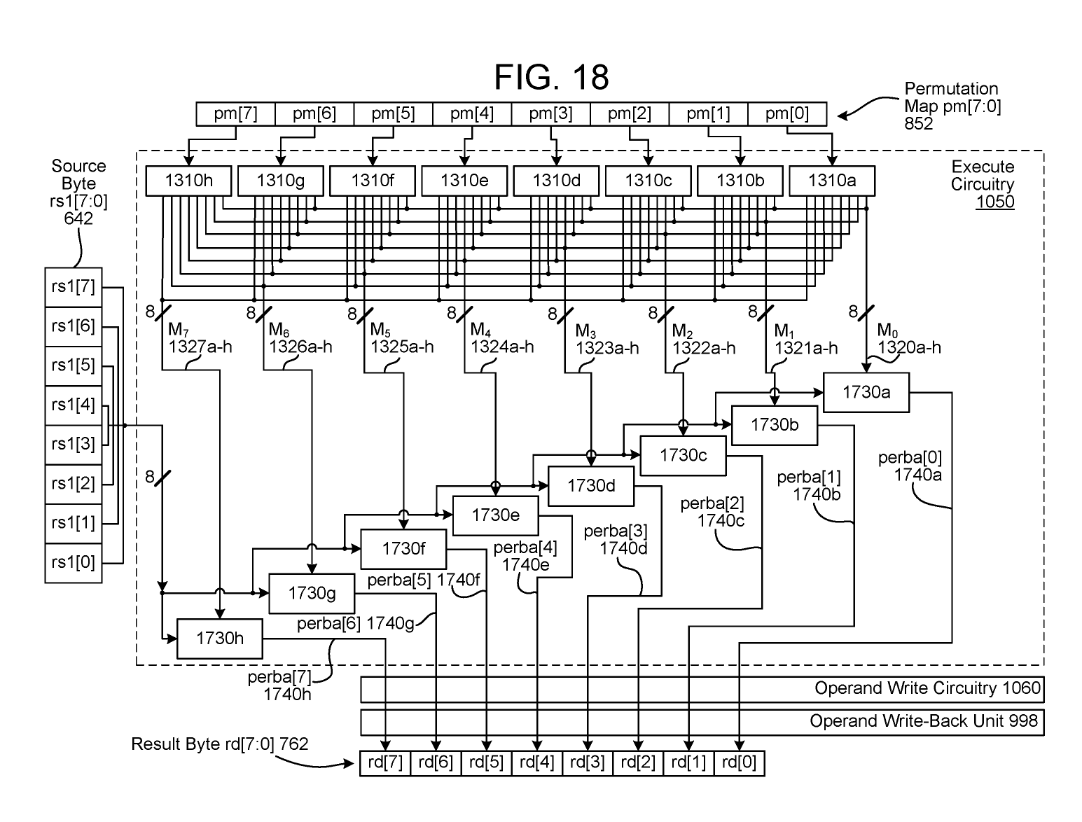

The inverters 1731a-h, the AND gates 1732a-h, the NOR gate 1734, the OR gate 1736, and the AND gate 1738 form a circuit mapped_band[0] 1730a that outputs one bit of the permutation perba[0] 1740a. This circuit mapped_band[n] 1730 is duplicated for each of the bits [7:0] of the PERBA result byte. This is further illustrated in FIG. 18, where the circuits mapped_band[7:0] 1730a to 1730h combine to produce the permuted byte perba[7:0] 1740a-1740h.

In FIG. 18, the eight M₀ outputs 1320a-h, as output by the eight permutation map nibble decoders 1310a-h, are input into the circuit mapped_band[0] 1730a, producing result bit perba[0] 1740a. The eight M₁ outputs 1321a-h, as output by the eight permutation map nibble decoders 1310a-h, are input into a circuit mapped_band[1] 1730b, producing result bit perba[1] 1740b. The eight M₂ outputs 1322a-h, as output by the eight permutation map nibble decoders 1310a-h, are input into a circuit mapped_band[2] 1730c, producing result bit perba[2] 1740c. And so on, with the eight M₇ outputs 1327a-h, as output by the eight permutation map nibble decoders 1310a-h, being input into the circuit mapped_band[7] 1730h, producing result bit perba[7] 1740h. Thus, the circuit in FIG. 18 executes the PERBA instruction to permute the source byte rs1[7:0] 642 into the result byte rd[7:0] 762.

The permutation map nibble decoders 1310a-h and the circuits mapped_band[7:0] 1730a-h may be part of the execute circuitry 1050 of the instruction pipeline 992, or may be included in circuitry associated with the execute circuitry 1050 of the instruction pipeline 992, such as in an ALU 994. In this way, the execute stage (1150) may execute an entirety of a PERBA instruction within a signal clock cycle.

Used in conjunction with other bit-field permute instructions or other bit-field swap and rotate instructions, an entire word may be permuted. A “bit-field” is a contiguous block of “r” bit(s), where r>0. Each bit-field of a plurality of bit-fields to be permuted consists of a same number of “r” bits. A bit is a bit-field of one bit, a nibble is a bit-field of four bits, a byte is a bit-field of eight bits, etc. Bit-field permute instructions may be implemented for bit-fields where r>1 in a similar manner to the illustrated bit-wise (i.e., r=1) permutation operations. To support such instructions, the execute circuitry 1050 and/or ALU 994 may include additional versions of the circuits in FIGS. 15-18 to permute nibbles, bytes, etc., instead of individual bits.

For example, a nibble-permute instruction operating on a thirty-two bit word may permute eight bit-fields of four bits each (i.e., r=4). An instruction format like that in FIG. 4 may be used, except instead of a single byte (rs[7:0] 642) being retrieved from the source byte register rs1 640 and a single byte (rd[7:0] 762) being written to the destination register rd 760, thirty-two bit words may be retrieved (e.g., rs[31:0]) and written (e.g., rd[31:0]). The permutation map nibble pm[0] 854a permutes source nibble rs[3:0], the permutation map nibble pm[1] 854b permutes source nibble rs[4:7], the permutation map nibble pm[2] 854c permutes source nibble rs[8:11], etc. The operations are identical to those discussed in connection with the PERBX and PERBA instructions, except instead of permuting bit-fields that are each a single bit, the bit-fields are each four bits.

As permuted, the transfer of bits within a source bit-field to a result bit-field maintains the “significance” of each bit. Continuing with the nibble-permute example, if only source nibble rs[3:0] is permuted to result nibble rd[7:4], then rd[7] is set to the state of rs[3], rd[6] is set to the state of rs[2], rd[5] is set to a state of rs[1], and rd[4] is set to a state of rs[0]. If both rs[7:4] and rs[11:8] are permuted to rd[3:0] using a PERBX operation, then rd[3] is set to an XOR of the states of rs[7] and rs[11]. rd[2] is set to an XOR of the states of rs[6] and rs[10], rd[1] is set to an XOR of the states of rs[5] and rs[9], and rd[0] is set to an XOR of the states of rs[4] and rs[8]. If no source bit-field is permuted to result bit-field rd[11:8], then each bit of rd[11:8] is set to a false state.

As noted above, other bit-field swap and rotate instructions may also be used in conjunction with the PERBA and PERBX instructions. Such swap instructions may be configured to rearrange bit-fields in a specific manner, such as reducing the significance of each byte in a word, while moving the least-significant byte to the most significant byte in a circular manner. So, for example, applying such a swap/rotate instruction to an input word in[31:0] to obtain an output word out[31:0], the contents of in[31:24] would be copied to out[23:16], the contents of in[23:16] would be copied to out[15:8], the contents of in[15:8] would be copied to out[7:0], and the contents of in[7:0] would be copied to out[31:24].

As is known in the art, “states” in binary logic may be represented by two voltage levels: high or low. The example circuits herein are discussed in the context of a positive logic convention, sometimes referred to as “active high,” where a “true” equals high, and “false” equals low. However, the principles disclosed herein are equally applicable to a negative logic convention, sometimes referred to as “active low,” where a “true” equals low and a “false” equals high.

In the discussion of FIG. 8B, it is stated that the “E” data field 858 of each nibble specifies whether a source bit rs1[n] is or is not to be mapped to the destination register rd 760. If “E” is equal to true (1), the source bit is not mapped. Otherwise, if “E” is equal to false (0), the source bit is mapped as specified by the offset in the TBO data field. However, this is simply a design choice, and as an alternative, the reverse can be used: “E” data field is false (0), the source bit is not mapped, and if the “E” data field is true (1), the source bit is mapped as specified by the offset in the TBO data field. If this reversed logic is used, then the permutation map nibble decoder 1310n in FIG. 13 is modified by eliminating inverter 1314, such that an input of each of the AND gates 1316a-h receives the state of the “E” data field 858.

The processor 900 may use any architecture, and may use any instruction set (e.g., RISC or CISC), with the addition of the permutation instructions and circuit enhancements described herein, to add the PERBX and PERBA operations to the architecture's execute circuitry 1050 and/or ALU 994. Also, although the operand registers 984 and instruction format 420 in the examples are 32 bits, other bit widths may be used.

Although the example source and result permutations are of a byte (8 one-bit bit-fields), a smaller permutation (e.g., two bit-fields or four bit-fields) or a larger permutation (e.g., 16 bit-fields) may be used, increasing or decreasing the number of TBO bits 856 accordingly (e.g., one TBO bit for two bit-field permutations, two TBO bits for four bit-field permutations, four TBO bits for sixteen bit-field permutations.

Depending upon the number of the bit-fields permuted and the width of the operand registers 984, more than one operand register 984 may be used to store the permutation map. If more than one operand register is used to store the permutation map, the instruction format 420 may include a single permutation map rs2 register address (e.g., 426), with the register address indicating a first operand register of a series of operand registers containing the permutation map to be fetched for the permutation operation.

Also, as an alternative to including a permutation map register address 426 in the instruction format, depending upon the size of the permutation map and the number of bits afforded by the instruction format, the permutation map may be directly encoded into the instruction as a series of binary values consisting of the E data field values 858 and TBO data field values 856.

Also, although least-significant bit of the source bits rs1 642 in FIG. 6A is illustrated as being the least significant bit of the source register rs1 640 (i.e., rs1[0]), and least-significant bit of the result bits rd 762 in FIG. 7A is illustrated as the least significant bit of the destination register rd 760 (i.e., rd[0]), other arrangements are possible. The source bits/bit-fields may be a range of contiguous bits/bit-fields such as rs1[b:a], where (b−a)≧1 and a≧0. Likewise, the result bits/bit-fields may be a range of contiguous bits such as rd[d:c], where (d−c)≧1, a≧0, and (b−a)=(d−c). The ranges may be configured in hardware or firmware, or specified by an additional data field or fields added to the instruction format (e.g., added to instruction format 420 in FIG. 4).

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers, microprocessor design, and pipeline architectures should recognize that components and process steps described herein may be interchangeable with other components or steps, or combinations of components or steps, and still achieve the benefits and advantages of the present disclosure. Moreover, it should be apparent to one skilled in the art, that the disclosure may be practiced without some or all of the specific details and steps disclosed herein.

As used in this disclosure, the term “a” or “one” may include one or more items unless specifically stated otherwise. Further, the phrase “based on” is intended to mean “based at least in part on” unless specifically stated otherwise.

What is claimed is:

1. A processor including circuitry to execute a permutation with exclusive OR (“XOR”) operation on a plurality of source bits, comprising:
a first register to store the plurality of source bits;
a second register or registers to store a plurality of permutation maps, wherein each permutation map of the plurality of permutation maps:
corresponds to a source bit of the plurality of source bits,
includes a first bit indicating whether the corresponding source bit is to be mapped to a result bit of a plurality of result bits, and
includes a plurality of second bits indicating a binary number;
a third register to which the plurality of result bits is to be written;
a plurality of permutation map decoder circuits, wherein each permutation map decoder circuit of the plurality of permutation map decoder circuits:
corresponds to a source bit of the plurality of source bits,
receives a permutation map of the corresponding source bit as input, and
outputs a plurality of map bits, wherein each map bit:
corresponds to a result bit of the plurality of result bits,
is true if the corresponding source bit is to be written to the corresponding result bit, and
is false if the corresponding source bit is not to be written to the corresponding result bit;
a plurality of combinational logic circuits, wherein each combinational logic circuit:
corresponds to a result bit of the plurality of result bits,
receives the plurality of source bits and each of the map bits corresponding to the result bit, and comprises:
a plurality of first circuits performing AND operations, each first circuit receiving a source bit of the plurality of source bits and the map bit output by the permutation map decoder circuit corresponding to the source bit, and
a second circuit performing an XOR operation on outputs of the plurality first circuits to determine a value of the corresponding result bit; and
a write circuit that stores each value of the plurality of result bits in the third register.

2. The processor of claim 1, wherein a first permutation map decoder circuit of the plurality of permutation map decoder circuits corresponds to a first source bit of the plurality of source bits and a first permutation map of the plurality of permutation maps, the first permutation map decoder circuit comprising:
a binary decoder circuit that converts the plurality of second bits of the first permutation map into a plurality of decoded bits, wherein a decoded bit having a position equal to the binary number indicated by the second bits is true and decoded bits having positions not equal to the binary number indicated by the second bits are false; and
wherein the first permutation map decoder circuit:
outputs the decoded bits as the plurality of map bits if the first bit of the first permutation map indicates that the first source bit is to be mapped, and
outputs false for all of the map bits of the plurality of map bits if the first bit of the first permutation map indicates that the first source bit is not to be mapped.

3. The processor of claim 1, where the processor comprises an instruction pipeline, and the plurality of permutation map decoder circuits and the plurality of combinational logic circuits are part of an execute stage of the instruction pipeline.

4. The processor of claim 1, wherein the processor is configured to execute instructions of an instruction set comprising a first machine language instruction specifying the permutation with XOR operation, the first machine language instruction having a first data field containing an opcode of the permutation with XOR operation, a second data field containing a first address of the first register, a third data field containing a second address of the second register, and a third data field containing a third address of the third register.

5. A processor including circuitry to execute a permutation with AND operation on a plurality of source bits, comprising:
a first register to store the plurality of source bits;
a second register or registers to store a plurality of permutation maps, wherein each permutation map of the plurality of permutation maps:
corresponds to a source bit of the plurality of source bits,
includes a first bit indicating whether the corresponding source bit is to be mapped to a result bit of a plurality of result bits, and
includes a plurality of second bits indicating a binary number;
a third register to which the plurality of result bits is to be written;
a plurality of permutation map decoder circuits, wherein each permutation map decoder circuit of the plurality of permutation map decoder circuits:
corresponds to a source bit of the plurality of source bits,
receives a permutation map of the corresponding source bit as input, and
outputs a plurality of map bits, wherein each map bit:
corresponds to a result bit of the plurality of result bits,
is true if the corresponding source bit is to be written to the corresponding result bit, and
is false if the corresponding source bit is not to be written to the corresponding result bit;
a plurality of combinational logic circuits, wherein each combinational logic circuit:
corresponds to a result bit of the plurality of result bits,
receives the plurality of source bits and each of the map bits corresponding to the result bit, and comprises:
a plurality of first circuits performing AND operations, each first circuit receiving a NOT of a source bit of the plurality of source bits and the map bit output by the permutation map decoder circuit corresponding to the source bit,
a second circuit performing a NOR operation on outputs of the plurality first circuits;
a third circuit performing an OR operation on all of the map bits corresponding to the result bit; and
and a fourth circuit performing an AND operation on outputs of the second circuit and the third circuit to determine a value of the corresponding result bit; and
a write circuit that stores each value of the plurality of result bits in the third register.

6. The processor of claim 5, wherein a first permutation map decoder circuit of the plurality of permutation map decoder circuits corresponds to a first source bit of the plurality of source bits and a first permutation map of the plurality of permutation maps, the first permutation map decoder circuit comprising:
a binary decoder circuit that converts the plurality of second bits of the first permutation map into a plurality of decoded bits, wherein a decoded bit having a position equal to the binary number indicated by the second bits is true and decoded bits having positions not equal to the binary number indicated by the second bits are false; and
wherein the first permutation map decoder circuit:
outputs the decoded bits as the plurality of map bits if the first bit of the first permutation map indicates that the first source bit is to be mapped, and
outputs false for all of the map bits of the plurality of map bits if the first bit of the first permutation map indicates that the first source bit is not to be mapped.

7. The processor of claim 5, where the processor comprises an instruction pipeline, and the plurality of permutation map decoder circuits and the plurality of combinational logic circuits are part of an execute stage of the instruction pipeline.

8. The processor of claim 5, wherein the processor is configured to execute instructions of an instruction set comprising a first machine language instruction specifying the permutation with AND operation, the first machine language instruction having a first data field containing an opcode of the permutation with AND operation, a second data field containing a first address of the first register, a third data field containing a second address of the second register, and a third data field containing a third address of the third register.

9. A method comprising:
receiving a plurality of source bit-fields;
receiving a plurality of permutation maps, wherein each permutation map of the plurality of permutation maps:
corresponds to a source bit-field of the plurality of source bit-fields,
includes a first bit indicating whether the corresponding source bit-field is to be mapped to a result bit-field of a plurality of result bit-fields, and
includes a plurality of second bits indicating a binary number;
determining, by a decoding logic circuit for each source-bit field, whether that source bit-field is to be mapped to a result bit-field of the plurality of result bit-fields, based on the first bit of the permutation map corresponding to the source bit-field;
determining, by the decoding logic circuit for each of the source bit-fields that is to be mapped, the result bit-field to which the source bit-field is mapped, in accordance with the binary number indicated by the plurality of second bits of the permutation map corresponding to that source bit-field;
setting, by a combinational logic circuit, each bit of each of the result bit-fields to which none of the source bit-fields is mapped to a false state;
setting, by the combinational logic circuit, each bit of each of the result bit-fields to which exactly one of the source bit-fields is mapped to a state of a corresponding bit of the source bit-field mapped to that result-bit-field;
setting, by the combinational logic circuit, each bit of the result bit-fields to which two or more of the source bit-fields are mapped to a state based on a combination of states of corresponding bits of the two or more source bits-fields; and
outputting the plurality of result bit-fields, there being a same number of source bit-fields and result bit-fields.

10. The method of claim 9, wherein for each result bit-field to which two or more of the source bit-fields are mapped, the states of the bits of the result bit-field are an exclusive OR (“XOR”) of the states of the corresponding bits of the two or more source bit-fields.

11. The method of claim 10, wherein for each source bit-field that is to be mapped, determining the result bit-field to which the source-bit field is mapped comprises decoding the binary number as a plurality of map bits for that source bit-field, each map bit corresponding to a result bit-field of the result bit-fields, the map bit to which the source-bit field is mapped being decoded as having a true state, with a remainder of the map bits being decoded to be the false state,
the method further comprising:
for each source bit-field that is not to be mapped, setting all of the map bits for that source bit-field to the false state; and
for each result bit-field:
determining an AND of each map bit corresponding to the result bit-field with the corresponding bits of the source bit-field corresponding to the map bit; and
determining an XOR of all of the ANDs,
wherein the setting of each bit of the result bit-field is based on the XOR of all the ANDs.

12. The method of claim 9, wherein for each result bit-field to which two or more of the source bit-fields are mapped, the state of the bits of the result bit-field are an AND of the states of the corresponding bits of the two or more source bit-fields.

13. The method of claim 12, wherein for each source bit-field that is to be mapped, determining the result bit-field to which the source-bit field is mapped comprises decoding the binary number as a plurality of map bits for that source bit-field, each map bit corresponding to a result bit-field of the result bit-fields, the map bit to which the source-bit field is mapped being decoded as having a true state, with a remainder of the map bits being decoded to be the false state,
the method further comprising:
for each source bit-field that is not to be mapped, setting all of the map bits for that source bit-field to the false state; and
for each of the result bit-field:
determining an AND of each map bit corresponding to the result bit-field with a NOT of corresponding bits of source bit-field corresponding to the map bit;
determining a NOR of all of the ANDs that were determined for each of the map bits corresponding to the result-bit field;
determining an OR of all of the map bits corresponding to the result bit-field; and
determining an AND of the NOR and the OR,
wherein the setting of each bit of the result bit-field is based on the AND of the NOR and the OR.

14. The method of claim 9, further comprising:
receiving a machine language instruction comprising an opcode specifying a permutation operation, a first address specifying a first location in memory storing the plurality of source bit-fields, a second address specifying a second location in memory storing the plurality of permutation maps, and a third address specifying a third location in memory where the plurality of result bit-fields are to be stored,
wherein:
receiving the plurality of source bit-fields comprises fetching the plurality of source bit-fields from the first location,
receiving the plurality of permutation maps comprises fetching the plurality of permutation maps from the second location, and
outputting the plurality of result-bit fields comprises writing the plurality of result bit-fields to the third location.

15. The method of claim 9, wherein at least two of the source bit-fields are mapped to a same result bit-field, and at least one of the source bit-fields is not mapped to any of the result bit-fields.

16. A processor configured to execute a permutation operation on a plurality of source bits, comprising:
a first register to store the plurality of source bits;
a second register or registers to store a plurality of permutation maps, wherein each permutation map of the plurality of permutation maps:
corresponds to a source bit of the plurality of source bits,
indicates whether the corresponding source bit is to be mapped to a result bit of a plurality of result bits, and
indicates a binary number;
a third register to which the plurality of result bits is to be written;
means for decoding each of the permutation maps to determine whether each of the corresponding source bits is to be mapped to a result bit of the plurality of result bits, and for each source bit that is to be mapped to a result bit, to determine the result bit based on the binary number; and
means for permuting the source bits into the result bits in accordance with the decoded permutation maps.

17. The processor of claim 16, wherein the means for permuting is configured to:
set each of the result bits to which none of the source bits is mapped to a false state;
set each of the result bits to which exactly one of the source bits is mapped to a state of the source bit; and
set each of the result bits to which two or more of the source bits is mapped to a state based on a combination of states of the two or more source bits.

18. The processor of claim 17, wherein for each result bit to which two or more of the source bits are mapped, the state of the result bit is an exclusive OR (“XOR”) of the states of the two or more source bits.

19. The processor of claim 17, wherein for each result bit to which two or more of the source bits are mapped, the state of the result bit is an AND of the states of the two or more source bits.

20. The processor of claim 16, where the processor comprises an instruction pipeline, and the means for decoding and the means for permuting are part of, or operate in conjunction with, an execute stage of the instruction pipeline.
